(19) United States
(12) Patent Application Publication
(10) Pub. No.: US 2026/0068863 A1
(43) Pub. Date: Mar. 12, 2026

(54) COMPRESSIBLE TOPWATER FLOATING LURE WITH ENHANCED HOOK GAP

(71) Applicant: AMERICAN BAITWORKS CO., Ocean Springs, MS (US)

(72) Inventor: Bailey Boutries, Ocean Springs, MS (US)

(21) Appl. No.: 19/210,798

(22) Filed: May 16, 2025

Related U.S. Application Data
(60) Provisional application No. 63/691,698, filed on Sep. 6, 2024.

(51) Int. Cl. A01K 93/00; A01K 85/00

(52) U.S. Cl. CPC A01K 93/00; A01K 85/1811; A01K 85/1847

(57) ABSTRACT

A topwater floating lure comprises a body and at least one fishhook. The body has a density to float on water and is compressible to have a resting configuration and a compressed configuration in response to a fish bite. The body has at least one channel defined in an outer surface thereof. The at least one fishhook is connected to the body and cooperates with a corresponding one of the at least one channel. The fishhook comprises a shank, a bend and a point where a hook gap is defined between the point and the shank. The hook gap is occupied by part of the body in the resting position, and the shank is aligned with the corresponding channel and is displaced therein when the body moves to the compressed configuration to increase hook gap exposure.

### CROSS-REFERENCE TO RELATED APPLICATIONS

This application claims the benefit of U.S. Provisional Patent Application No. 63/691,698, filed Sep. 6, 2024, the contents of which are incorporated by reference in their entirety as if fully set forth herein.

### TECHNICAL FIELD

The technical field generally relates to fishing lures, and in particular to compressible topwater floating lures with enhanced hook gap capabilities.

### BACKGROUND

Soft body floating topwater lures can have issues related to reduced hook gaps when compressed. A reduced hook gap can lead to a lower likelihood of setting the hook in response to a fish bite. There is a need for a technology that overcomes at least some of the challenges in this field.

### SUMMARY

According to some aspects, there is provided a topwater floating lure comprising: a body having a density to float on water and being compressible to have a resting configuration and a compressed configuration in response to a fish bite, the body having at least one channel defined in an outer surface thereof; at least one fishhook connected to the body and cooperating with a corresponding one of the at least one channel, the fishhook comprising a shank, a bend and a point where a hook gap is defined between the point and the shank; wherein the hook gap is occupied by part of the body in the resting position, and the shank is aligned with the corresponding channel and is displaced therein when the body moves to the compressed configuration to increase hook gap exposure.

In some implementations, the body is hollow and comprises a wall that defines an inner cavity. In some implementations, the wall is composed of a flexible material. In some implementations, the wall is composed of plastisol, PVE, PVC or silicone. In some implementations, the wall is configured such that opposed sides of the wall are capable of touching each other in the compressed configuration. In some implementations, the body has a front, a rear, a top and a bottom; the at least one channel is located along a portion of the rear and the bottom; and the at least one fishhook is arranged so that the bend is located proximate to the rear and the point is located proximate to the top when the body is in the resting configuration. In some implementations, in the compressed configuration, a portion of the bend also displaces with respect to the at least one channel to move within a part of the at least one channel. In some implementations, the at least one channel is sized and configured to receive all of the shank therein. In some implementations, the at least one channel is sized and configured to have a depth that is greater than a diameter of the shank. In some implementations, a length of the at least one channel is between 0.25 and 1 inch; and a depth of the at least one channel is between 0.125 and 0.5 inch. In some implementations, the length of the at least one channel is between 0.5 and 0.75 inch; and the depth of the at least one channel is between 0.25 and 0.5 inch. In some implementations, the bend of the fishhook has a shape corresponding to an exterior contour of the body. In some implementations, the at least one channel extends an entire length of the body. In some implementations, the at least one fishhook includes two points and the at least one channel includes two channels. In some implementations, the two channels are arranged in parallel relation to each other. In some implementations, each point of the at least one fishhook is pointing forward and outside from the body, one pointing on each side of the body. In some implementations, in the compressed configuration, the at least one channel is stretched according to the bend of the fishhook. In some implementations, the at least one channel is configured such that the hook gap exposure is at least 60%. In some implementations, the at least one channel has a banana-shaped cross-section. In some implementations, the body has a frog-like shape.

According to further optional aspects, there is provided a lure comprising: a body that is compressible to have a resting configuration and a compressed configuration in response to a fish bite; at least one fishhook connected to the body, the fishhook comprising a shank, a bend and a point where a hook gap is defined between the point and the shank, wherein the hook gap is occupied by part of the body in the resting position; and a hook gap exposer configured to increase hook gap exposure when the body moves to the compressed configuration.

In some implementations, the hook gap exposer comprises a channel provided in the body to receive a corresponding one of the at least one fishhook in the compressed configuration. In some implementations, the hook gap exposer is configured to reduce upward pressure of the fishhook on the body in the compressed position.

According to still further aspects, there is provided a topwater floating body for use in a lure, wherein the topwater floating body has a density to float on water and is compressible to have a resting configuration and a compressed configuration in response to a fish bite, the body comprising at least one channel defined in an outer surface thereof for receiving at least a portion of a fishhook in the compressed configuration.

In some implementations, the topwater floating body is hollow and comprises a wall that defines an inner cavity. In some implementations, the wall is composed of a flexible material. In some implementations, the wall is composed of plastisol, PVE, PVC or silicone. In some implementations, the wall is configured such that opposed sides of the wall are capable of touching each other in the compressed configuration. In some implementations, the topwater floating body has a front, a rear, a top and a bottom; and the at least one channel is located along the rear and the bottom. In some implementations, the at least one channel is sized and configured to have a depth that is between 0.125 and 0.5 inches and a length between 0.25 and 1 inch. In some implementations, the length of the at least one channel is between 0.5 and 0.75 inch and the depth of the at least one channel is between 0.25 and 0.5 inch. In some implementations, the at least one channel extends an entire length of the topwater floating body. In some implementations, the at least one channel includes two channels. In some implementations, the two channels are arranged in parallel relation to each other. In some implementations, the at least one channel is configured such that a distance between the top and the bottom of the topwater floating body is at least 60%. In some implementations, the at least one channel has a banana-shaped cross-section. In some implementations, the topwater floating body has a frog-like shape.

### BRIEF DESCRIPTION OF THE DRAWINGS

The attached figures illustrate various features, aspects and implementations of the technology described herein.

FIG. 1 is a side elevation view of a topwater floating lure in a compressed configuration without channels.

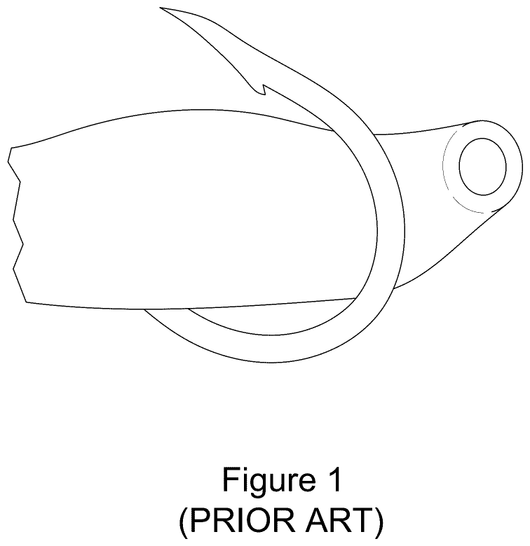

FIG. 2 is a side elevation view of a topwater floating lure in a resting configuration in accordance with an embodiment.

FIG. 3 is a cross-section view of the topwater floating lure in accordance with an embodiment.

FIG. 4 is a perspective view of the topwater floating lure in accordance with an embodiment.

FIG. 5 is a side elevation view of the topwater floating lure in a compressed configuration in accordance with an embodiment.

FIG. 6A, FIG. 6B, FIG. 6C, and FIG. 6D, hereinafter FIG. 6, are cross-sectional views of different channel shapes in accordance with some embodiments.

FIG. 7A, FIG. 7B, FIG. 7C, and FIG. 7D, hereinafter FIG. 7, are top views of example lure bodies having different channel shapes in accordance with some embodiments.

FIG. 8A, FIG. 8B, FIG. 8C, and FIG. 8D, hereinafter FIG. 8, are cross-sectional views of positions of fishhooks with respect to the channels in accordance with some embodiments.

FIG. 9 is a top view of the body having different shapes in accordance with an embodiment.

FIG. 10A and FIG. 10B, hereinafter FIG. 10, are top views of the body in different configurations in accordance with an embodiment.

FIG. 11A, FIG. 11B, FIG. 11C, and FIG. 11D, hereinafter FIG. 11, are top views of example bodies of FIG. 7 without fishhooks in accordance with an embodiment.

FIG. 12 is a bottom view of the topwater floating lure in accordance with an embodiment.

### DETAILED DESCRIPTION

The present description relates to a topwater floating lure with enhanced capabilities in terms of the hook gap as well as related methods. The lure can have a configuration such that in response to compression from a fish bite which can cause an opposed part of the lure to bulge, an enhanced hook gap is nevertheless enabled to provide improved hook setting.

In some embodiments, the topwater floating lure includes a body and at least one fishhook connected to the body. The body can be configured to float on water and to be compressible. The body has a resting configuration in which a hook gap of the fishhook is notably occupied by a part of the body and the fishhook is arranged so that a bend thereof is located proximate to a rear of the body and the point of the fishhook is located further toward to the top of the body. In the resting configuration the hook can generally align with the body to help avoid snagging on weeds and other flora. The body also has a compressed configuration (e.g., when a fish bites the lure), where a portion of the hook gap is exposed to facilitate setting the hook. The lure is further configured such that in the compressed configuration the hook gap is well exposed, which can be accomplished by providing a channel or other means such that the part of the body adjacent the hook does not significantly occupy the hook gap.

As will be described further below, in one preferred embodiment, the body has at least one channel on its outer surface that allows an improved compression of the body in the compressed configuration which, in turn, helps expose the hook gap. In the case where multiple fishhooks are provided on the body, each fishhook can cooperate with a corresponding channel.

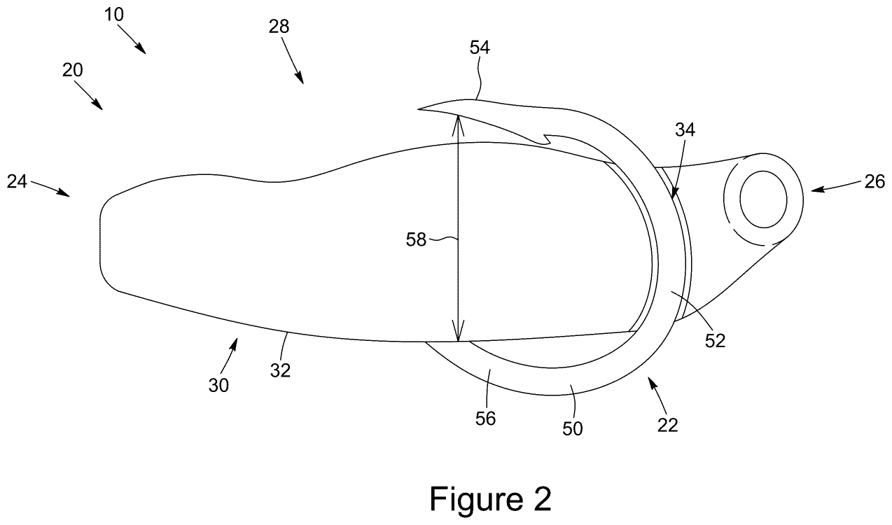

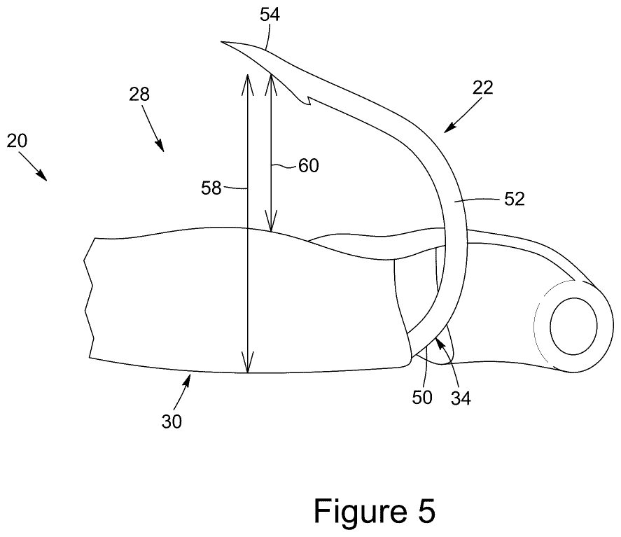

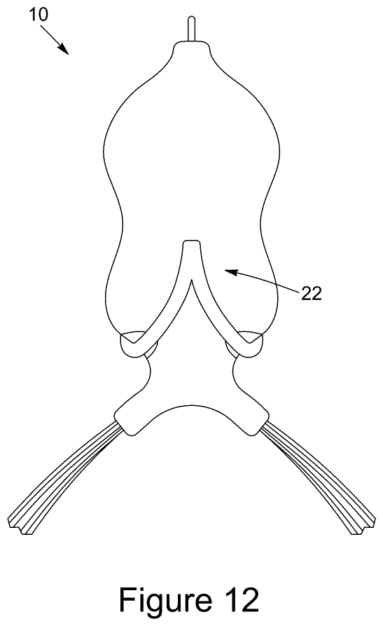

With reference to FIGS. 2, 5 and 12, a side view of an example of the topwater floating lure 10 is shown. The topwater floating lure 10 has a body 20 and at least one fishhook 22. The body 20 of the topwater floating lure 10 can have a floating construction (i.e., having an overall density to float on water), which can be enabled by the body being hollow and air-filled. The body 20 is compressible and has two general configurations: a resting configuration where the body 20 is not compressed and a compressed configuration where the body 20 is compressed and can have an overall volume smaller than in the resting configuration. The body 20 can generally regain the resting configuration once a force that creates the compressed configuration is released. Depending on the location of the compressive force (e.g., the fish bite location), the body can have different compressed configurations, while the resting configuration can be generally the same as the body returns to its initial shape. FIG. 2 shows an example resting configuration, while FIG. 5 shows an example compressed configuration.

Still referring to FIG. 2, the body 20 has a front 24, a rear 26, a top 28 and a bottom 30 which together generally define an outer surface 32 of the body 20. In the embodiment shown in FIG. 2, the outer surface 32 of the body 20 has a frog-like shape. It is noted that the body 20 can have various other shapes that may or may not mimic a food of a target fish. The body 20 can also have various shapes and sizes, some of which are shown in the figures.

In some embodiments, the body 20 includes at least one channel 34 that facilitates hook gap exposure in the compressed configuration. For example, two channels 34 can be located at the rear 26 of the body 20 in alignment with respective fishhooks. The position of the channels 34 can be provided relative to the position of the fishhooks 22 and will be discussed further below. In other embodiments, the body 20 can have multiple channels 34 located at different positions on the outer surface 32 and the shape of the channels can be different from one channel to another. The channels 34 can have various shapes, sizes and configurations to facilitate reception of part of the fishhooks to help expose additional hook gap space.

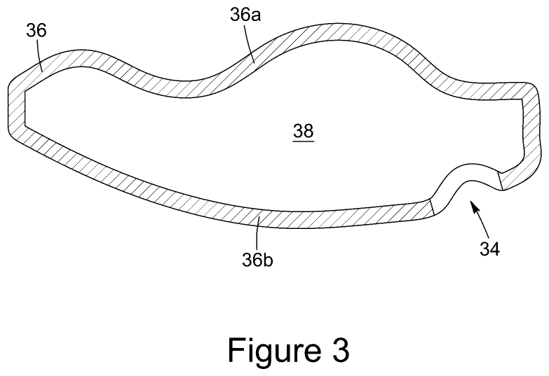

Now referring to FIG. 3, the body 20 can be hollow with a wall 36 defining an inner cavity 38. The thickness of the hollow body can vary depending on the material of the wall, the size and the weight of the body, the type of fish that the lure is designed for, and so on. The material can be flexible to enable compressibility of the body. The body can be composed of various materials, such as Plastisol, PVE, PVC and silicone. The wall 36 can be composed of a flexible material such that the body 20 can change volume and/or shape from the resting configuration to the compressed configuration and vice versa, therefore changing the volume and/or the shape of the inner cavity 38. More specifically, the wall 36 has opposite sides 36a, 36b that can come into contact with each other in the compressed configuration if sufficient pressure is exerted. In some embodiments, the at least one channel 34 can be as deep as the thickness of the wall 36. The channel 34 can be a groove that is provided within the wall or can be defined by an undular shape of the wall itself. It is also noted that the channel 34 can be not as deep as the thickness of the hollow body, in the sense that the channel would not pass all the way through the wall and thus the inner cavity 38 remains sealed from water at the channel location. Nevertheless, the wall of the body could be formed such that the channel is formed by an undulating portion of the wall itself to produce a deep channel that has a depth greater than the thickness of the wall itself. In some embodiments, the channel 34 has a banana-shaped cross-section in the sagittal plane, similar to the shape of the back of the fishhook. In a preferred embodiment, a height of the channel 34 is less than ¾ inch. In other embodiments, the height (e.g., length) of the channel 34 can be between 0.25 and 1 inch or between 0.5 and 0.75 inch. The functioning and various potential features of the channels will be described in more detail below.

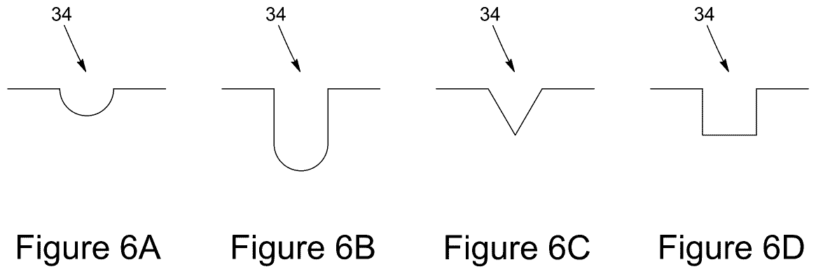

Referring to FIG. 6, some examples of the shape of the channel in the frontal plane are shown. In FIG. 6a, the channel 34 can have a half-oval shape, a half-ellipse shape or a half-circle shape. In FIG. 6b, the channel 34 can have one of the shapes of FIG. 6a but being a deeper U-shaped or half-stadium shaped channel. In FIG. 6c, the channel 34 can be a V-shaped channel. In FIG. 6d, the channel 34 can be a square-shaped or rectangular-shaped channel. The channel profile can depend on manufacturing techniques, fishhook characteristics, or other considerations. A preferred depth of the channel 34 is ¼ inch. In other embodiments, the depth of the channel 34 can be between 0.125 and 0.5 inch or between 0.25 and 0.5 inch. In some embodiments, the channel 34 can have a different shape than those previously mentioned or a combination thereof and be configured to receive the fishhook 22.

Referring back to FIG. 2, the fishhook 22 has a shank 50 including a bend 52 and a point 54 at the extremity of the shank 50. In the embodiment shown, the shank 50 has a semicircular shape around the body 20 and the bend 52 is curved on about 180 degrees. The point 54 can be almost parallel to a bottom section 56 of the shank 50. A distance between the bottom section 56 and the point 54 is referred to as the hook gap 58. In this embodiment, a hook gap exposure is created between the top 28 of the body 20 and the point 54 of the fishhook 22, in the same direction as the hook gap 58. In the resting configuration, the hook gap exposure is small or non-existent which can facilitate avoiding snags when topwater fishing. In the compressed configuration, the hook gap exposure increases and can be a notable proportion of the hook gap 58 itself. FIG. 5 shows an example where a notable hook gap exposure 60 is created in the compressed configuration.

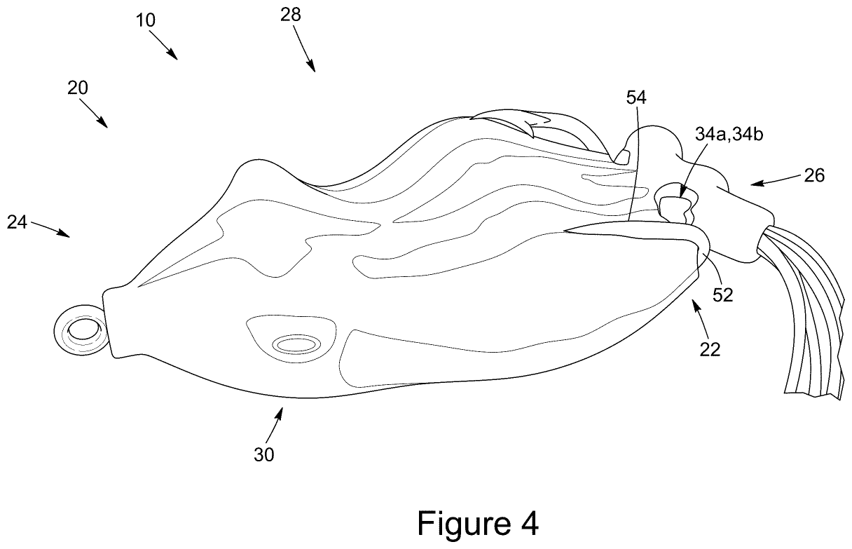

In the embodiment shown in FIG. 4, the fishhook 22 has one shank 50 that split into two points 54a, 54b. The fishhook 22 has therefore two bends 52a, 52b and two points 54a, 54b. The fishhook 22 is inserted into the body 20 so that the shank 50 enters the body 20 at the front thereof and exists at the bottom 30 through a small hole in the body 20. The small hole is approximately the same size as the shank 50 or even smaller so there is a minimal amount of water that enters the body 20. There is not enough water entering the body 20 to affect the floatability of the lure 10. The fishhook 22 can be inserted manually or automatically into the body 20.

The shank 50 of the fishhook 22 is designed so that the bends 52a, 52b follow the contour of the rear 26 of the body 20 and end with the points 54a, 54b at the top 28 of the body 20, facing the front 24 and outside of the body 20.

In other embodiments not shown, the shape of the body 20 can vary. For example, the shape of the body 20 can be similar to the shape of the bend 52 of the fishhook 22 as previously explained. In another example, the shape of the back of the body 20 can be thinner than the shape of the bend 52 of the fishhook 22. In still another example, the shape of the back of the body 20 is thicker than the shape of the bend 52 of the fishhook 22.

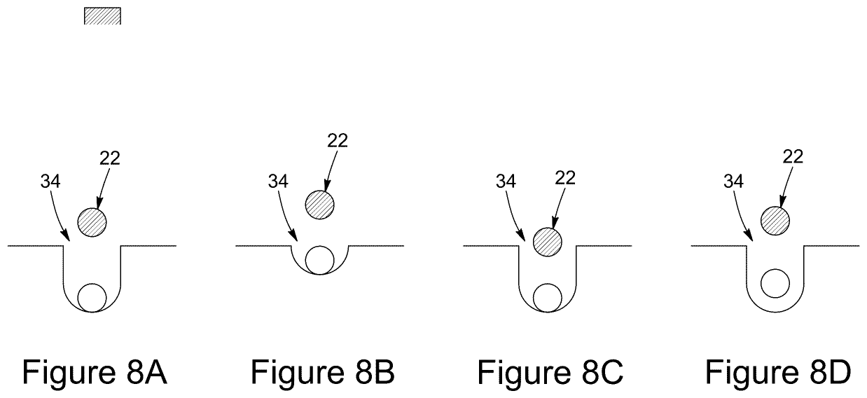

In the preferred embodiment, a portion of the shank 50 including but not limited to a portion of each bend 52a, 52b cooperates with corresponding channels 34a, 34b of the body 20 in the compressed configuration. In some embodiments, the fishhook does not interact with the channels 34a, 34b in the resting configuration. Referring to FIG. 8, examples of the interaction of the fishhook 22 with the channel 34 are shown. In FIG. 8a, the fishhook 22 is outside of the channel 34 in the resting configuration and completely inside the channel 34 and touching the end thereof in the compressed configuration. In FIG. 8b, the fishhook 22 is outside the channel 34 in the resting configuration and partially inside the channel 34 and not touching the end thereof in the compressed configuration. In FIG. 8c, the fishhook 22 is partially inside the channel in the resting configuration and totally inside the channel 34 and touching the end thereof in the compressed configuration. In FIG. 8d, the fishhook 22 is completely outside the channel 34 in the resting configuration and completely inside the channel and not touching the end thereof in the compressed configuration. In some embodiments, there can be different interactions of the fishhook 22 with the channel 34 and combinations thereof.

The channels 34a, 34b can be sized and configured so that all of the shank 50 fits within the channels 34a, 34b at least in the compressed configuration. More particularly, the channels can be sized and configured to have a depth that is at least a diameter of the shank 50, therefore hiding a portion of the fishhook within part of the body 20 in the resting configuration. The dimensions of the channel 34 depends on the fishhook style, the fishhook size and the body size. The bends 52a, 52b can be parallel to a length of the channels 34a, 34b. The bends 52a, 52b and the points 54a, 54b of the fishhook 22 can also be parallel to one another or having an angle so that the points 54a, 54b are pointing outwardly or inwardly from the body 20.

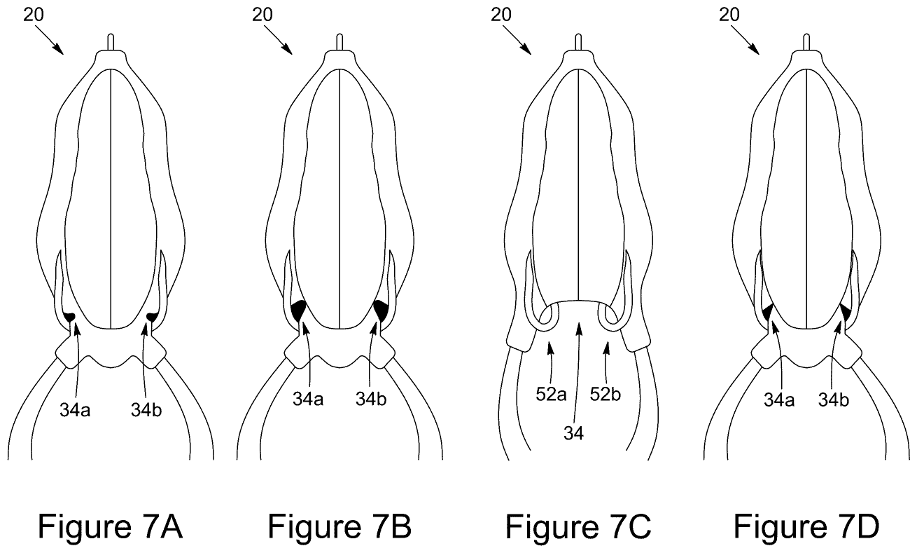

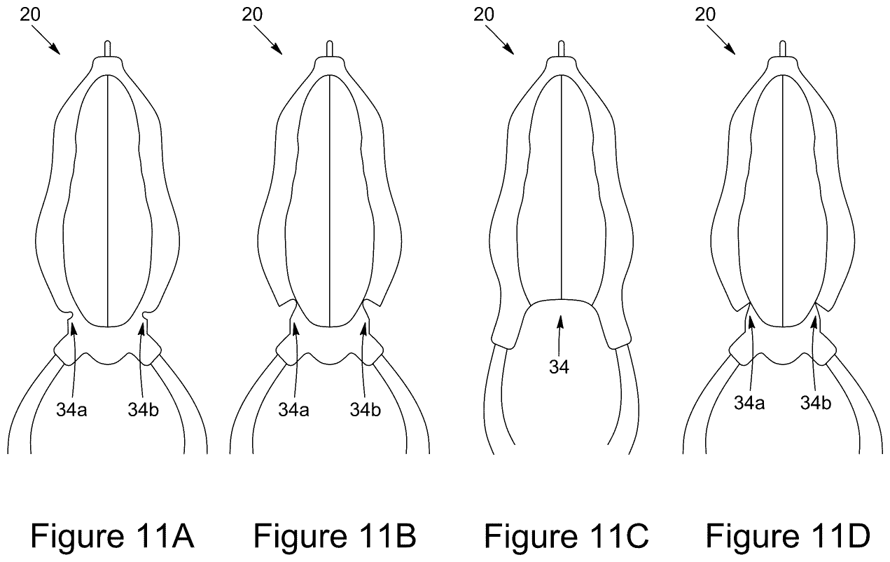

Referring now to FIGS. 7 and 11, some examples of channels 34 are shown. In FIGS. 7a, 7b, 11a and 11b, the channels 34a, 34b are similar to the ones presented in the embodiments of FIGS. 2, 4 and 5. The channels 34a and 34b are bigger than the diameter of the fishhook 22. In FIGS. 7c and 11c, there is one large channel 34 that englobes the two bends 52a, 52b. In FIGS. 7d and 11d, the channels 34a and 34b are narrower than the one from FIGS. 7a, 7b, 11a and 11b. In some embodiments, the shape and the width of the channels 34 can be different.

In the embodiment shown in FIG. 4, in the resting configuration, the fishhook 22 is not visible on the body 20 from the front 24. This is advantageous as the fish cannot see the point 54, but also because it creates a weedless fishhook. In other words, when the fisher fishes with the lure 10, the fishhook 22 does not catch the weed on top of the water and stays free from weed, debris and other vegetation that can float on water.

Referring now to FIG. 5, when the body 20 is compressed from the resting configuration to the compressed configuration, the top 28 of the body 20 is compressed towards the bottom 30 thereof. As the top 28 of the body 20 is lowered towards the bottom 30, the at least one channel 34 allows the rear section of the body 20 to receive the at least one fishhook 22 enhancing the hook gap exposure, which could be almost as large as the hook gap 58 itself. The at least one channel 34 can be designed to stretch (and therefore to become wider) in the compressed configuration to enhance the lowering of the top 28 of the body 20 and reception of the shank 50 and bend 52 of fishhook 22 therein. In some embodiments, a portion of the bend 52 can be displaced within a part of the at least one channel 34 when the body 20 is moved to the compressed configuration. Without the channels or other region to receive the fishhooks, the rear section of the body can bulge and/or not experience flattening when the front section of the body is compressed, leading to a relatively small hook gap exposure. The channels 34 enable the rear section of the body 20 to be flattened and/or to lower to provide enhanced hook gap exposure 60 in the compressed configuration.

In existing topwater frog lures, the hook gap exposure is relatively small, such as 30% or less of the hook gap. In a preferred embodiment of the present technology, the hook gap exposure is increased to at least 60%, at least 65%, at least 70%, at least 75%, at least 80% or up to 85% of the hook gap, for example. The hook gap exposure can be influenced by the plastic hardness, the size of the body, the size of the fishhook, the shape of the hook, etc.

It is noted that the shape of the fishhook 22 as well as the cooperation of the fishhook 22 with the body 20 and the at least one channel 34 can vary in other embodiments not shown herein. It is also noted that other configurations can be provided to enhance the hook gap exposure in the compressed configuration.

It is noted that while the channels can provide the enhanced hook gap exposure, other constructions and features of the body can be provided to enhance hook gap exposure. Some of such alternative constructions will be described below.

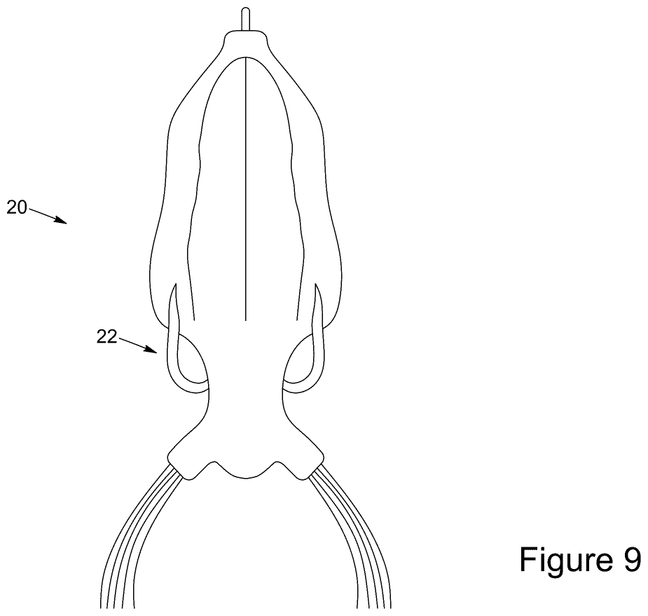

In the embodiment shown in FIG. 9, the body 20 has a shape so that no channel is required to create an enhancement in the hook gap exposure in the compressed configuration. Therefore, when the body 20 is compressed from the resting configuration to the compressed configuration, the fishhook 22 does not interfere with the ability of the body 20 to be compressed.

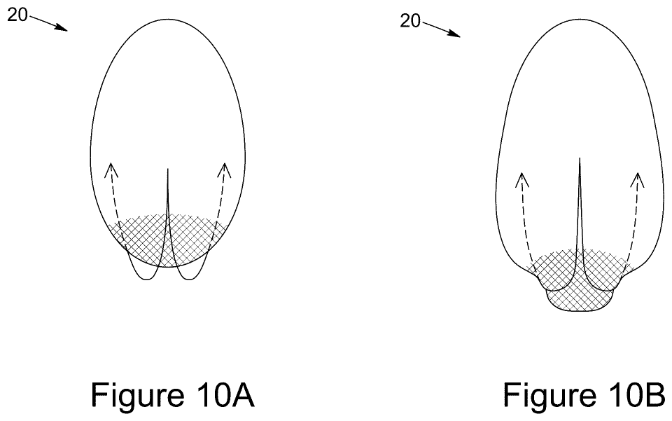

In another embodiment shown in FIG. 10, instead of having predefined channels, the body 20 can have at least one section at the back made with a highly flexible material (i.e., a material that is more flexible than the material used for the rest of the body) that stretches when the body 20 is compressed in the compressed configuration, creating therefore temporary channel regions in contact with the fishhooks. Once the pressure on the lure is removed, the body 20 goes back to its original shape and the temporary channel regions disappear. In another embodiment (not shown), the body can be designed so that the back of the body does not touch the fishhook even in the compressed configuration. It is noted that in all the embodiments, the lure is designed so that it does not become caught on weeds during fishing and thus the fishhooks and body cooperate accordingly in the resting configuration.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

1. A topwater floating lure comprising:
a body having a density to float on water and being compressible to have a resting configuration and a compressed configuration in response to a fish bite, the body having at least one channel defined in an outer surface thereof;
at least one fishhook connected to the body and cooperating with a corresponding one of the at least one channel, the fishhook comprising a shank, a bend and a point where a hook gap is defined between the point and the shank; and
wherein the hook gap is occupied by part of the body in the resting position, and the shank is aligned with the corresponding channel and is displaced therein when the body moves to the compressed configuration to increase hook gap exposure.

2. The topwater floating lure according to claim 1, wherein the body is hollow and comprises a wall that defines an inner cavity.

3. The topwater floating lure according to claim 2, wherein the wall is composed of a flexible material.

4. The topwater floating lure according to claim 3, wherein the wall is composed of plastisol, PVE, PVC or silicone.

5. The topwater floating lure according to claim 2, wherein the wall is configured such that opposed sides of the wall are capable of touching each other in the compressed configuration.

6. The topwater floating lure according to claim 1, wherein:
the body has a front, a rear, a top and a bottom;
the at least one channel is located along a portion of the rear and the bottom; and
the at least one fishhook is arranged so that the bend is located proximate to the rear and the point is located proximate to the top when the body is in the resting configuration.

7. The topwater floating lure according to claim 1, wherein, in the compressed configuration, a portion of the bend also displaces with respect to the at least one channel to move within a part of the at least one channel.

8. The topwater floating lure according to claim 1, wherein the at least one channel is sized and configured to receive all of the shank therein.

9. The topwater floating lure according to claim 1, wherein the at least one channel is sized and configured to have a depth that is greater than a diameter of the shank.

10. The topwater floating lure according to claim 1, wherein a length of the at least one channel is between 0.25 and 1 inch; and a depth of the at least one channel is between 0.125 and 0.5 inch.

11. The topwater floating lure according to claim 1, wherein the at least one channel extends an entire length of the body.

12. The topwater floating lure according to claim 1, wherein the at least one fishhook includes two points and the at least one channel includes two channels.

13. The topwater floating lure according to claim 12, wherein the two channels are arranged in parallel relation to each other.

14. The topwater floating lure according to claim 12, wherein each point of the at least one fishhook is pointing forward and outside from the body, one pointing on each side of the body.

15. The topwater floating lure according to claim 1, wherein the at least one channel is configured such that the hook gap exposure is at least 60%.

16. A lure comprising:
a body that is compressible to have a resting configuration and a compressed configuration in response to a fish bite;
at least one fishhook connected to the body, the fishhook comprising a shank, a bend and a point where a hook gap is defined between the point and the shank, wherein the hook gap is occupied by part of the body in the resting position; and
a hook gap exposer configured to increase hook gap exposure when the body moves to the compressed configuration.

17. The lure of claim 16, wherein the hook gap exposer comprises a channel provided in the body to receive a corresponding one of the at least one fishhook in the compressed configuration.

18. The lure of claim 17, wherein the hook gap exposer is configured to reduce upward pressure of the fishhook on the body in the compressed position.

19. A topwater floating body for use in a lure, wherein the topwater floating body has a density to float on water and is compressible to have a resting configuration and a compressed configuration in response to a fish bite, the body comprising at least one channel defined in an outer surface thereof for receiving at least a portion of a fishhook in the compressed configuration.

20. The topwater floating body according to claim 19, wherein the topwater floating body is hollow and comprises a wall that defines an inner cavity.

21. The topwater floating body according to claim 20, wherein the wall is composed of a flexible material.

22. The topwater floating body according to claim 21, wherein the wall is composed of plastisol, PVE, PVC or silicone.

23. The topwater floating body according to claim 20, wherein the wall is configured such that opposed sides of the wall are capable of touching each other in the compressed configuration.

24. The topwater floating body according to claim 19, wherein:
the topwater floating body has a front, a rear, a top and a bottom; and
the at least one channel is located along the rear and the bottom.

25. The topwater floating body according to claim 19, wherein the at least one channel is sized and configured to have a depth that is between 0.125 and 0.5 inches and a length between 0.25 and 1 inch.

26. The topwater floating body according to claim 19, wherein the at least one channel extends an entire length of the topwater floating body.

27. The topwater floating body according to claim 19, wherein the at least one channel includes two channels are arranged in parallel relation to each other.

28. The topwater floating body according to claim 19, wherein the at least one channel is configured such that a distance between a top and a bottom of the topwater floating body is at least 60%.
